(19) United States
(12) Patent Application Publication
(10) Pub. No.: US 2024/0220770 A1
(43) Pub. Date: Jul. 4, 2024

(54) HIGH-EFFICIENT QUANTIZATION METHOD FOR DEEP PROBABILISTIC NETWORK

(71) Applicant: SHANGHAITECH UNIVERSITY, Shanghai (CN)

(72) Inventors: Shen ZHANG, Shanghai (CN); Xinzhe LIU, Shanghai (CN); Yajun HA, Shanghai (CN)

(73) Assignee: SHANGHAITECH UNIVERSITY, Shanghai (CN)

(21) Appl. No.: 18/387,463

(22) Filed: Nov. 7, 2023

Related U.S. Application Data
(63) Continuation of application No. PCT/CN2023/083268, filed on Mar. 23, 2023.

(30) Foreign Application Priority Data
Dec. 30, 2022 (CN) 202211723983.2

(51) Int. Cl. G06N 3/04; G06N 5/04; G06N 7/01

(52) U.S. Cl. CPC G06N 3/04; G06N 5/04; G06N 7/01

(57) ABSTRACT

A high-efficient quantization method for a deep probabilistic network achieves good result through hybrid quantization, structure reformulation, and type optimization. Firstly, for a directed acyclic graph (DAG) structure, all nodes in the DAG are clustered, and each node is quantized by a specific arithmetic type based on the clustering category, to obtain a preliminarily quantized deep probabilistic network. Secondly, the multi-in nodes in a preliminarily quantized deep probabilistic network are reformulated based on the input weights, structural reformulation converts a multi-in node into a binary tree network containing only two-input nodes, and parametrical reformulation is performed on the reformulated structure. Finally, arithmetic types of all nodes are optimized by using an arithmetic type search method based on power consumption analysis and network accuracy analysis. The method can significantly reduce computational complexity and energy consumption for computing while maintaining model accuracy of the deep probabilistic network.

### CROSS REFERENCE TO THE RELATED APPLICATIONS

This application is the continuation application of International Application No. PCT/CN2023/083268, filed on Mar. 23, 2023, which is based upon and claims priority to Chinese Patent Application No. 202211723983.2, filed on Dec. 30, 2022, the entire contents of which are incorporated herein by reference.

### TECHNICAL FIELD

The present disclosure relates to a model quantization technology, and in particular, to a high-efficient quantization method for a deep probabilistic network.

### BACKGROUND

As a machine learning model different from a neural network, a deep probabilistic network has the advantages of strong theoretical support and high model robustness, such that the deep probabilistic network can simultaneously perform structure learning and parameter learning, and can perform various types of inference tasks. The deep probabilistic network has been applied in fields such as speech recognition, natural language processing, and image recognition.

As a machine learning model based on probability theory, the deep probabilistic network is of an irregular directed acyclic graph (DAG) structure and mainly involves a floating-point operation in the form of a probability. In order to successfully deploy the deep probabilistic network on edge hardware, it is necessary to perform model quantization to reduce model computation, computational complexity and system energy consumption. However, due to differences in network structure and computing paradigm, most existing quantization methods are only applicable to the neural network model and cannot be applied to the deep probabilistic network.

However, the deep probabilistic network includes a plurality of computing nodes that together form a DAG, and all data involved is a probability value of a floating-point type. This means that the deep probabilistic network has a large computational workload, high computational complexity, and high energy consumption. Due to limitations on computing power and power consumption, it is difficult to deploy a deep probabilistic network model on an edge device.

In order to resolve this problem, relevant experts have performed explorations in different aspects. In the series of works [1], a new hardware-aware cost indicator is introduced in a network training phase to balance a contradiction between computational efficiency and model performance during final deployment. However, this work only adjusts the scale of the model without quantizing the model. In the series of works [2], a static quantization scheme for a probabilistic network with low-precision inference is proposed. According to this scheme, an arithmetic type required for network computation is selected by analyzing the error boundary of the model and power consumption model of the hardware. In the series of works [3], impacts of the floating-point type, a posit type, and a logarithmic type on inference of the deep probabilistic network are compared, and an application condition of each of these three types is summarized. In the series of works [2] and [3], only a same quantization type is globally used in the network, and a result obtained through analysis is more pessimistic than an actual requirement, resulting in the still high computational complexity of the network. In the series of works [4], an Int32 data type is directly used for network quantization, but actual model accuracy is significantly decreased.
[1] Galindez Olascoaga, Laura I., et al. Towards hardware-aware tractable learning of probabilistic models[C] Advances in Neural Information Processing Systems 32 (2019).
[2] N. S. et al., Problp: A framework for low-precision probabilistic inference[C] in DAC, 2019, p. 190.
[3] Sommer, Lukas, et al. Comparison of arithmetic number formats for inference in sum-product networks on FPGAs[C] 2020 IEEE 28th Annual international symposium on field-programmable custom computing machines (FCCM). IEEE, 2020.
[4] Choi, Young-kyu, Carlos Santillana, Yujia Shen, Adnan Darwiche, and Jason Cong. FPGA Acceleration of Probabilistic Sentential Decision Diagrams with High-Level Synthesis[C]ACM Transactions on Reconfigurable Technology and Systems (TRETS) (2022).

### SUMMARY

A high-efficient quantization method for a deep probabilistic network is proposed to address a deployment problem of a deep probabilistic network on an edge device.

The present disclosure adopts a following technical solution: A high-efficient quantization method for a deep probabilistic network specifically includes the following steps:
1) when a structure of the deep probabilistic network is a DAG, clustering each node in the graph to obtain each cluster, and assigning an arithmetic type with different precision based on a characteristic of a clustering category of each cluster, and preliminarily quantizing each node by using the assigned arithmetic type, to obtain a preliminarily quantized deep probabilistic network;
2) reformulating a structure of a multi-in node for the preliminarily quantized deep probabilistic network, specifically, reformulating, based on an input weight, the multi-in node into a binary tree network containing only two input nodes to achieve branch clustering and reformulation of each cluster; and adjusting a weight parameter of the reformulated binary tree network to achieve parameter reformulation; and
3) optimizing a quantization scheme by using an arithmetic type search method based on an optimization strategy.

Further, step 1) is specifically implemented according to a following method:
1.1) layering all nodes based on a depth of each node in the network, and dividing the entire network into a plurality of clusters;
1.2) performing model inference by using data in a dataset based on a double-precision floating-point arithmetic type, recording a dynamic data range of each cluster in the network, and then performing statistical analysis on a data distribution of each cluster;
1.3) dynamically adjusting a cluster affiliation of each node based on an overall data range of the cluster and a data range of each node to reduce a data distribution range of each cluster;
1.4) specifying an appropriate arithmetic type for each cluster based on an adjusted data distribution characteristic of the cluster; and
1.5) preliminarily quantizing each node based on the specified arithmetic type.

Further, step 2) is specifically implemented according to a following method:
2.1) taking a logarithm with two as a base for weights of all input branches of the multi-in node, rounding a result down, dividing the input branches into a plurality of clusters based on the indicator, and marking the indicator as Iₙ and a corresponding cluster as Cₙ;
2.2) sorting each cluster based on a size of Iₙ organizing the cluster into a form of the binary tree network, marking a newly generated input branch as B, and setting an initial weight of the input branch to 1, where a cluster Cₙ with a larger Iₙ is closer to a root node;
2.3) randomly arranging a node in each cluster to obtain a binary tree, such that the structure of the deep probabilistic network is reformulated;
2.4) amplifying weight parameters of all input branches of each cluster in a same proportion to reduce an impact of accuracy underflow; and
2.5) adjusting a weight coefficient of the input branch B to offset the impact in step 2.4) to restore a calculation result to a normal value.

Further, step 3) is specifically implemented according to a following method:
3.1) analyzing an arithmetic type used in a preliminary quantization scheme to construct larger-range arithmetic type selection space as search space, and sorting the search space based on an expression capability of the arithmetic type in an ascending order;
3.2) evaluating importance of each cluster in an initial network for overall model accuracy, and setting a priority of the cluster based on an evaluation indicator; and
3.3) determining the arithmetic type of each cluster in order based on the priority.

Further, the arithmetic type search method based on the optimization strategy in step 3) is an arithmetic type search method based on power consumption analysis and network accuracy analysis, and dynamically adjusts the arithmetic type of each cluster based on specified power consumption and accuracy requirements to obtain an optimized network configuration.

The present disclosure has following beneficial effects: The high-efficient quantization method for a deep probabilistic network in the present disclosure can be widely applied to edge hardware deployment of various deep probabilistic networks, especially customized high-flexibility computing platforms represented by an FPGA platform and a universal computing platform that supports a plurality of types of arithmetic accuracy. The method can significantly reduce model computation, computational complexity, and system energy consumption while maintaining model accuracy of the deep probabilistic network.

### BRIEF DESCRIPTION OF THE DRAWINGS

FIG. 1 is an overall flowchart of a high-efficient quantization method for a deep probabilistic network according to the present disclosure;

FIG. 2 is a schematic diagram of a quantization effect of a hybrid quantization method for a DAG network according to the present disclosure;

FIG. 3A is a schematic structural diagram of a typical multi-in node according to the present disclosure:

FIG. 3B is a schematic diagram of an overall structure after an input branch is clustered and arranged according to the present disclosure; and

FIG. 3C is a schematic structural diagram of a final binary tree network after structure and parameter reformulation according to the present disclosure.

### DETAILED DESCRIPTION OF THE EMBODIMENTS

The present disclosure will be described in detail below with reference to the accompanying drawings and specific embodiments. The embodiments are implemented on the premise of the technical solutions of the present disclosure. The following presents detailed implementations and specific operation processes. The protection scope of the present disclosure, however, is not limited to the following embodiments.

High-efficient quantization is achieved for a deep probabilistic network through hybrid quantization, structure reformulation, and type optimization. Firstly, a hybrid quantization method for a DAG structure clusters each node in a graph, assigns an arithmetic type with different precision based on a characteristic of a clustering category, and preliminarily quantizes each node by using the assigned arithmetic type, to obtain a preliminarily quantized deep probabilistic network. Secondly, the hybrid quantization method reformulates a structure of a multi-in node for the preliminarily quantized deep probabilistic network, reformulates, based on an input weight, the multi-in node into a binary tree network containing only two input nodes, and performs weight and parameter reformulation on a reformulated structure. Finally, the hybrid quantization method optimizes a quantization scheme by using an arithmetic type search method based on an optimization strategy.

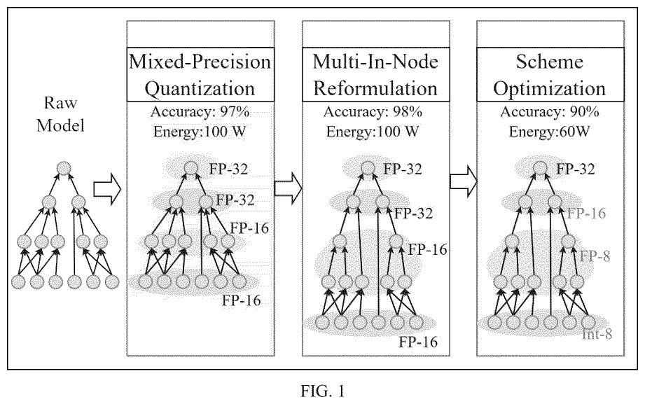

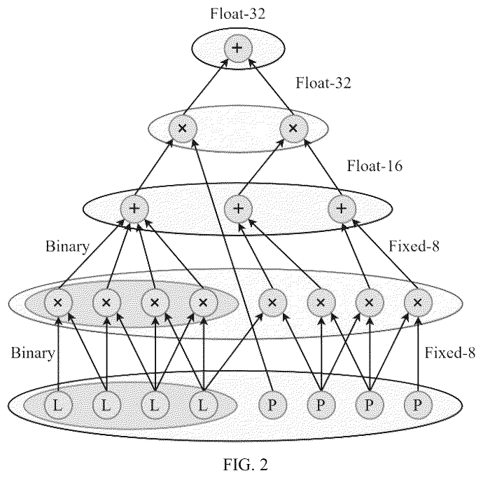

FIG. 1 is an overall flowchart of a high-efficient quantization method for a deep probabilistic network. A specific process is as follows:
1. For a deep probabilistic network, a hybrid quantization method is first used to preliminarily quantize a network model, as shown in FIG. 2. The method can cluster a node in a DAG, make appropriate adjustment based on dynamic data analysis, and also determine an appropriate quantization type for each cluster.

For the hybrid quantization method for the DAG, a node clustering method based on overall network structure analysis and dynamic node data analysis is proposed to divide a plurality of nodes of the deep probabilistic network into a plurality of clusters. In addition, an appropriate quantization type is specified for each cluster based on a result of the dynamic node data analysis. A specific implementation method is as follows:
1.1. All nodes are layered based on a depth of each node in the network, and the entire network is divided into the plurality of clusters.
1.2. Model inference is performed by using data in a dataset based on a double-precision floating-point arithmetic type, a dynamic data range of each cluster in the network is recorded, and then statistical analysis is performed on a data distribution of each cluster.
1.3. A cluster affiliation of each node is dynamically adjusted based on an overall data range of the cluster and a data range of each node to properly reduce a data distribution range of each cluster.
1.4. An appropriate arithmetic type is specified for each cluster based on an adjusted data distribution characteristic of the cluster.
1.5. Each node is preliminarily quantized based on the specified arithmetic type.
2. For a preliminarily quantized deep probabilistic network, a multi-in node reformulation method is used to convert a multi-in node into a binary tree network containing only two input nodes.

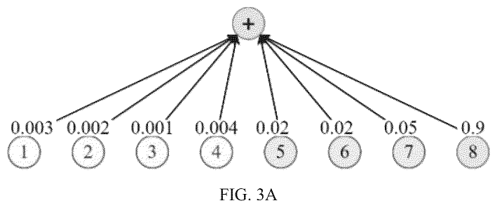

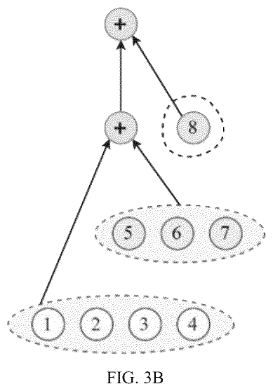

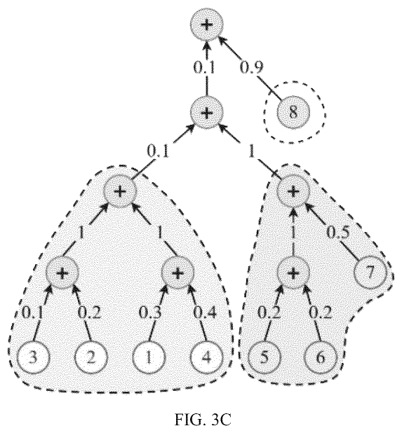

A plurality of input branches are divided into the plurality of clusters by using an input branch clustering method based on an input weight. Then, in a specific order, the multi-in node is converted into the binary tree network containing only the two input nodes. Finally, a parameter reformulation method is proposed, which can adjust a weight parameter of the binary tree network to reduce an accuracy loss in a calculation process. A specific implementation method is as follows:
2.1. As shown in FIG. 3A, a logarithm with two as a base is taken for weights of all input branches of the multi-in node, a result is rounded down, the input branches are divided into the plurality of clusters based on the indicator, and the indicator is marked as Iₙ and a corresponding cluster is marked as Cₙ.
2.2. Each cluster is sorted based on a size of Iₙ and is organized into a form of the binary tree network. A cluster Cₙ with a larger Iₙ is closer to a root node. In addition, a newly generated input branch is marked as B, and an initial weight of the input branch is set to 1.
2.3. A node in each cluster is randomly arranged to obtain a binary tree. So far, the deep probabilistic network is structurally reformulated. FIG. 3B is a schematic diagram of an overall structure after the input branch is clustered and arranged.
2.4. Weight parameters of all input branches of each cluster are amplified in a same proportion to reduce an impact of accuracy underflow.
2.5. A weight coefficient of the input branch B is adjusted to offset the impact in step 2.4 to restore a calculation result to a normal value. FIG. 3C is a schematic structural diagram of a final binary tree network after structure and parameter reformulation.
3) For the preliminarily quantized binary-tree deep probabilistic network, a quantization scheme is optimized by using an arithmetic type search method based on an optimization strategy. A specific implementation method is as follows.
3.1. An arithmetic type used in a preliminary quantization scheme is analyzed to construct larger-range arithmetic type selection space as search space. In addition, the search space needs to be sorted based on an expression capability of the arithmetic type in an ascending order.
3.2. Importance of each cluster in an initial network for overall model accuracy is evaluated, and a priority of the cluster is specified based on the indicator. During the evaluation, an average relative error of all nodes in the cluster can be used as the evaluation indicator.
3.3. The arithmetic type of each cluster is determined in order based on the priority. For a given cluster, arithmetic types can be selected one by one from the search space and attempted until a given arithmetic type can exactly meet an accuracy requirement of the model. During search, a certain cluster is not necessarily searched starting from a 0^{th} element in the selection space, but a start point of the search is determined based on a selection result of a previous cluster.

An arithmetic type search method based on power consumption analysis and network accuracy analysis can dynamically adjust the arithmetic type of each cluster based on specified power consumption and accuracy requirements to obtain an optimized network configuration. In addition, in order to ensure operational efficiency of the method, an optimization method is proposed to first specify a priority for each cluster based on an impact on network accuracy, and then perform the search layer by layer based on the priority. A start search point of a lower-priority cluster uses a search result of the previous cluster. The method can significantly reduce time and complexity of the search.

An experimental result on a BAUDIO dataset shows that the quantization method in the present disclosure can reduce model parameters by 20% and save a computational energy consumption by 34% under a condition similar to single-precision floating-point quantization accuracy. In addition, the quantization method in the present disclosure achieves optimal energy efficiency and precision configuration. Compared with a most advanced quantization method in the industry, the quantization method in the present disclosure can save 33% to 60% of an energy consumption while achieving similar accuracy.

The above embodiments are merely several implementations of the present disclosure. Although these embodiments are described specifically and in detail, they should not be construed as a limitation to the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. A high-efficient quantization method for a deep probabilistic network, comprising the following steps:
1) when a structure of the deep probabilistic network is a directed acyclic graph (DAG), clustering each node in the DAG to obtain each cluster, and assigning an arithmetic type with different precision based on a characteristic of a clustering category of each cluster, and preliminarily quantizing each node by using the assigned arithmetic type, to obtain a preliminarily quantized deep probabilistic network;
2) reformulating a structure of a multi-in node for the preliminarily quantized deep probabilistic network by reformulating, based on an input weight, the multi-in node into a binary tree network containing only two input nodes to achieve branch clustering and reformulation of each cluster; and adjusting a weight parameter of the reformulated binary tree network to achieve parameter reformulation; and
3) optimizing a quantization scheme by using an arithmetic type search method based on an optimization strategy.

2. The high-efficient quantization method for the deep probabilistic network according to claim 1, wherein step 1) comprises:
1.1) layering all nodes based on a depth of each node in the deep probabilistic network, and dividing the deep probabilistic network into a plurality of clusters;
1.2) performing model inference by using data in a dataset based on a double-precision floating-point arithmetic type, recording a dynamic data range of each cluster in the deep probabilistic network, and then performing statistical analysis on a data distribution of each cluster;
1.3) dynamically adjusting a cluster affiliation of each node based on an overall data range of the cluster and a data range of each node to reduce a data distribution range of each cluster;
1.4) specifying an appropriate arithmetic type for each cluster based on an adjusted data distribution characteristic of the cluster; and
1.5) preliminarily quantizing each node based on the specified arithmetic type.

3. The high-efficient quantization method for the deep probabilistic network according to claim 2, wherein step 2) comprises:
2.1) taking a logarithm with two as a base for weights of all input branches of the multi-in node to obtain a result, rounding the result down to obtain an indicator, dividing the input branches into a plurality of clusters based on the indicator, and marking the indicator as Iₙ and a corresponding cluster as Cₙ;
2.2) sorting each cluster based on a size of Iₙ, organizing the cluster into a form of the binary tree network, marking a newly generated input branch as B, and setting an initial weight of the input branch to 1, wherein a cluster Cₙ with a larger Iₙ is closer to a root node;
2.3) randomly arranging a node in each cluster to obtain a binary tree, such that the structure of the deep probabilistic network is reformulated;
2.4) amplifying weight parameters of all input branches of each cluster in a same proportion to reduce an impact of accuracy underflow; and
2.5) adjusting a weight coefficient of the input branch B to offset the impact in step 2.4) to restore a calculation result to a normal value.

4. The high-efficient quantization method for the deep probabilistic network according to claim 3, wherein step 3) comprises:
3.1) analyzing an arithmetic type used in a preliminary quantization scheme to construct larger-range arithmetic type selection space as search space, and sorting the search space based on an expression capability of the arithmetic type in an ascending order;
3.2) evaluating importance of each cluster in an initial network for overall model accuracy, and setting a priority of the cluster based on an evaluation indicator; and
3.3) determining the arithmetic type of each cluster in order based on the priority.

5. The high-efficient quantization method for the deep probabilistic network according to claim 1, wherein the arithmetic type search method based on the optimization strategy in step 3) is an arithmetic type search method based on power consumption analysis and network accuracy analysis, and dynamically adjusts the arithmetic type of each cluster based on specified power consumption and accuracy requirements to obtain an optimized network configuration.
